(19) United States
(12) Patent Application Publication
(10) Pub. No.: US 2015/0006022 A1
(43) Pub. Date: Jan. 1, 2015

(54) ELECTRONIC DEVICE AND VEHICLE MONITORING METHOD

(71) Applicant: HON HAI PRECISION INDUSTRY CO., LTD., New Taipei (TW)

(72) Inventor: CHENG-TA HSU, New Taipei (TW)

(21) Appl. No.: 14/315,753

(22) Filed: Jun. 26, 2014

(30) Foreign Application Priority Data
Jun. 28, 2013 (TW) 102123336

(51) Int. Cl. G07C 5/08; B60R 16/02; G08B 25/10

(52) U.S. Cl. CPC G07C 5/08; G08B 25/10; B60R 16/02
USPC 701/32.2

(57) ABSTRACT

An electronic device determines whether an accident happens to a vehicle according to a change of a speed of the vehicle, or a change of a gradient of the vehicle and location information of the vehicle. The electronic device generates rescue information upon the condition that the accident happens to the vehicle. The electronic device dials a predetermined telephone number and outputs the rescue information when the predetermined telephone number is connected.

### FIELD

The embodiments of the present disclosure relate to monitoring technology, and particularly to an electronic device and a vehicle monitoring method.

### BACKGROUND

When an accident happens to a vehicle, the driver needs to call a predetermined telephone number for help. However, if the driver is serious injured, he/she cannot make a call for help. In such a situation, it is dangerous for the driver if the driver has to wait for a long time.

### BRIEF DESCRIPTION OF THE DRAWINGS

Implementations of the present technology will now be described, by way of example only, with reference to the attached figures.

FIG. 1 is a diagrammatic view of one embodiment of an electronic device that is positioned on a vehicle connected to a data center.

FIG. 2 is a block diagram of one embodiment of a vehicle monitoring system in the electronic device in FIG. 1.

FIG. 3 is a flowchart illustrating one embodiment of a vehicle monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

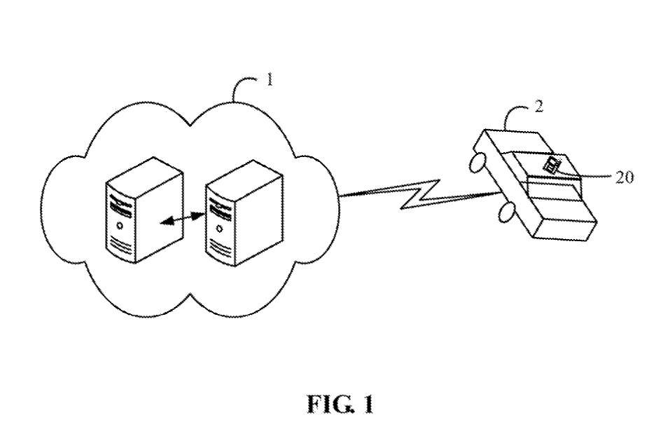

FIG. 1 illustrates a diagrammatic view of one embodiment of an electronic device that is positioned on a vehicle connected to a data center. In at least one embodiment, the electronic device 20 is positioned in the vehicle 2 and wirelessly connected to a data center 1 via a network (e.g., the Internet or a local area network), as shown in FIG. 1. The electronic device 1 may be, but is not limited to, a personal computer (PC), a tablet computer, a smart phone, a thin electronic device or any other device. The electronic device 1 can also be placed in a pocket of a driver of the vehicle 2.

The data center 1 is located behind a firewall and connected to the network. The firewall protects the data center 1 from unauthorized access and protects data in the data center 1 to avoid information leakage. The data center 1 is designed for cloud computing capability and capacity and includes a plurality of cloud servers. The data center 1 stores at least one electronic map. The electronic device 20 can determine a location on the electronic map when the electronic device 20 accesses to the electronic map of the data center 1. Furthermore, the electronic device 2 can store the at least one electronic map, and the data center 1 is unnecessary.

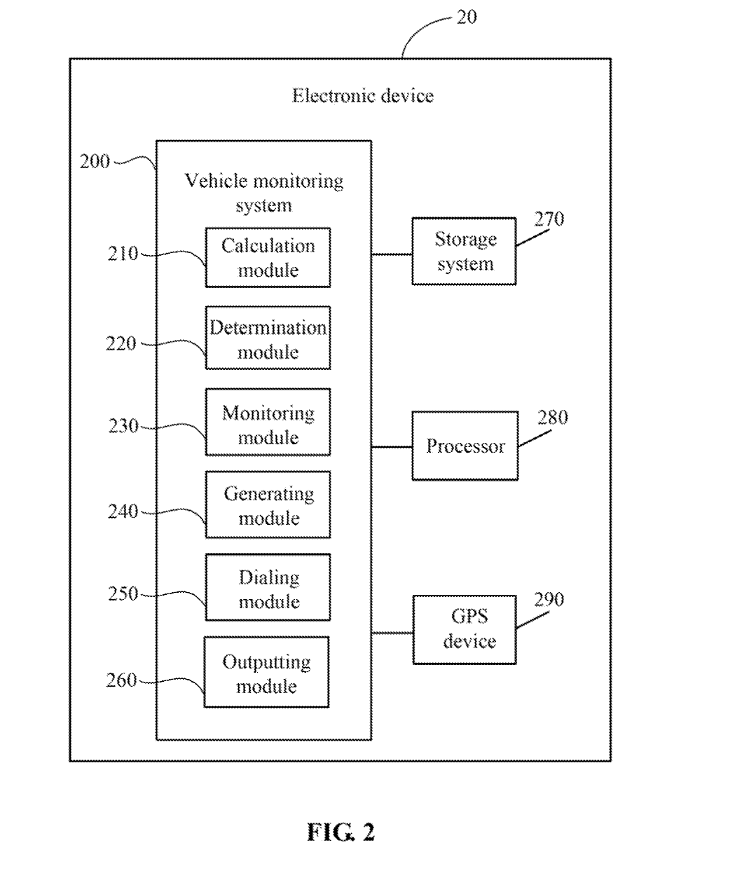

FIG. 2 is a block diagram of one embodiment of the electronic device including a vehicle monitoring system 200. In one embodiment, the electronic device 20 further includes a storage system 270, at least one processor 280, and a Global Positioning System (GPS) device 290. The vehicle monitoring system 200 includes a calculation module 210, a determination module 220, a monitoring module 230, a generating module 240, a dialing module 250, and an outputting module 260. The modules 210-260 can include computerized code in the form of one or more programs that are stored in the storage system 270. The computerized code includes instructions that are executed by at least one processor 280 to provide functions for the modules 210-260. The storage system 270 can be a cache or a memory, such as an EPROM, HDD, or flash memory. The GPS device 290 is used to generate location information of the electronic device 20. The electronic device 20 further includes a gradient device. The gradient device is used to detect a gradient of the vehicle 2.

The calculation module 210 calculates a speed of the vehicle 2 according to the location information of the vehicle 2. In one embodiment, the calculation module 210 reads the location information from the GPS device 290 at each predetermined time interval (for example, one second). The calculation module 210 calculation module 290 calculates the speed of the vehicle 2 according to the location information and the predetermined time interval.

The determination module 220 determines whether the calculated speed exceeds a predetermined threshold (for example, 60 km/h).

The monitoring module 230 monitors the vehicle 2 upon the condition that the calculated speed exceeds the predetermined threshold. The monitoring module 230 monitors a change of the speed of the vehicle 2, and a change of the gradient of the vehicle 2. In one embodiment, the monitoring module 230 monitors whether the speed of the vehicle 2 is dramatically decreased to zero in a predetermined duration (for example, five seconds). The monitoring module 230 further monitors whether the vehicle 2 turns over (that is, a rollover) according to the change of the gradient of the vehicle 2. Furthermore, the monitoring module 230 monitors whether the vehicle 2 is located on any road of the electronic map according the location information of the vehicle 2.

The determination module 220 determines whether an accident happens to the vehicle 2 according to the change of the speed of the vehicle 2, the change of the gradient of the vehicle and the location information of the vehicle 2. In one embodiment, the accident (for example, a crash or rollover) is determined to happen to the vehicle 2 when the speed of the vehicle 2 is dramatically decreased to zero in five second. The accident happens to the vehicle 2 when the gradient of the vehicle 2 is dramatically changed in five seconds. For example, the gradient of the vehicle 2 is changed from ten degrees to sixty degrees in five seconds, the accident is determined to happen to the vehicle 2. Furthermore, the accident is determined to happen to the vehicle 2 when the vehicle 2 is not located on any road of the electronic map.

The generating module 240 generates rescue information when an accident happens to the vehicle 2. The rescue information includes accident location information of the vehicle 2, an accident time, a name of the driver when the accident happens to the vehicle 2, and an image of the driver of the vehicle 2.

The dialing module 250 dials a predetermined telephone number. The predetermined telephone number can be a telephone number of a traffic police office which is closest to the location of the vehicle 2 or a telephone number of a person (e.g., a wife of the driver).

The outputting module 260 outputs the rescue information when a phone call to the predetermined telephone number is established. In at least one embodiment, the outputting module 260 activates a microphone of the electronic device 20 and outputs the rescue the information, so that the person of the predetermined telephone number knows what happens to the driver of the vehicle 2. In addition, the outputting module 260 further sends rescue information via a short message or an e-mail.

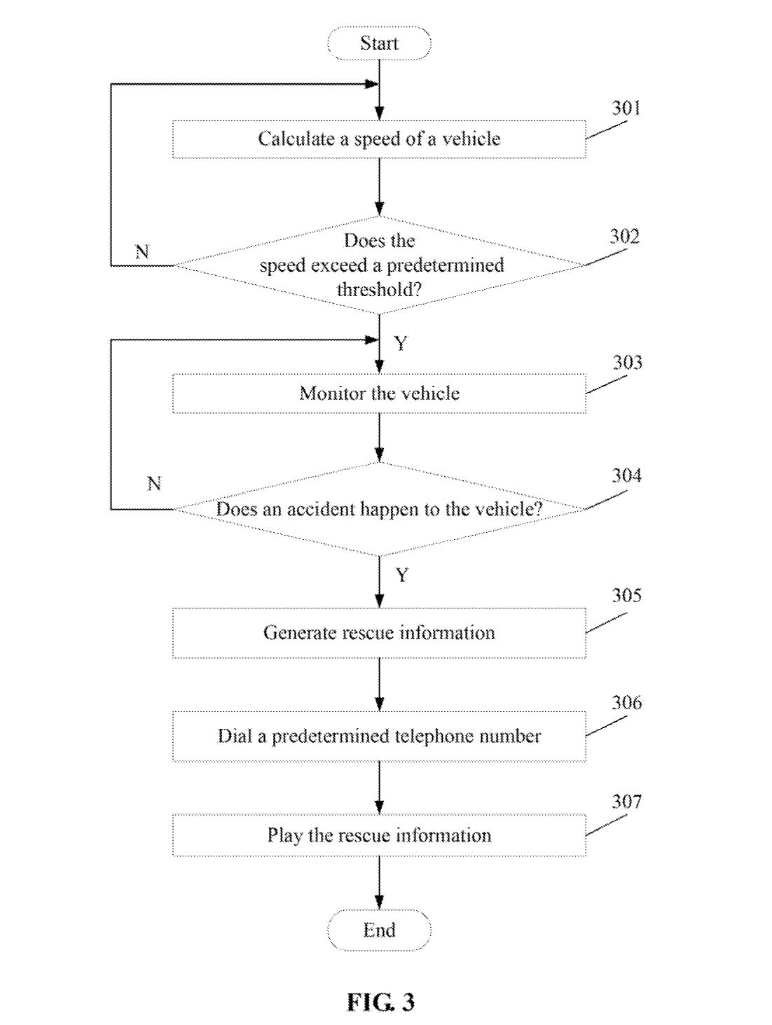

FIG. 3 is a flowchart illustrating one embodiment of a data tracking method. Depending on the embodiment, additional steps can be added, others deleted, and the ordering of the steps can be changed.

Referring to FIG. 3, a flowchart is presented in accordance with an example embodiment which is being thus illustrated. The method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the method 300. Additionally, the illustrated order of blocks is by example only and the order of the blocks can change according to the present disclosure. The method 300 can begin at block 301.

In block 301, a calculation module calculates a speed of the vehicle according to location information of the vehicle. In at least one embodiment, the calculation module reads the location information from the GPS device during the predetermined time interval. The calculation module calculation module calculates the speed of the vehicle according to the location information and the predetermined time interval. The speed of the vehicle is calculated by the formula: S=D/T, where S represents the speed of the vehicle, D represents a distance between two locations which are obtained from the GPS device in the predetermined time, and T represents the predetermined time interval.

In block 302, a determination module determines whether the calculated speed exceeds a predetermined threshold. In at least one embodiment, if the calculated speed exceeds a predetermined threshold, the procedure goes to block 303. Otherwise, if the calculated speed does not exceed the predetermined threshold, the procedure returns to block 301.

In block 303, a monitoring module monitors the vehicle upon the condition that the calculated speed exceeds the predetermined threshold. The monitoring module monitors a change of the speed of the vehicle and a change of the gradient of the vehicle. In one embodiment, the speed of the vehicle decreases from 70 km/h to zero in five seconds, the monitoring module determines the speed of the vehicle dramatically changes, the vehicle incurs a crash. The monitoring module further monitors whether the vehicle turns over according to the change of the gradient of the vehicle. The monitoring module monitors whether the vehicle is located on any road of the electronic map. In at least one embodiment, the accident (for example, a crash) is determined to happen to the vehicle when the speed of the vehicle dramatically decreases to zero in a predetermined duration. The vehicle is determined to have the accident (for example, a rollover) when the gradient of the vehicle is dramatically changed in the predetermined duration. Furthermore, the accident is determined to happen to the vehicle when the vehicle is not on any road of the electronic map.

In block 304, the determination module further determines whether an accident happens to the vehicle according to the change of the speed of the vehicle, the change of the gradient of the vehicle and the location information of the vehicle. In at least one embodiment, if the vehicle has the accident, the procedure goes to block 305. Otherwise, if the vehicle has no accident, the procedure returns to block 303.

In block 305, a generating module generates rescue information when the accident happens to the vehicle. The rescue information includes accident location information of the vehicle obtained from the GPS device, and an accident time obtained from a clock of the electronic device, a name of the driver when the accident happens to the vehicle.

In block 306, a dialing module dials a predetermined telephone number. The predetermined telephone number can be a telephone number of a traffic police office which is closest to the location of the vehicle or a telephone number of a person (e.g., a wife of the driver).

In block 307, an outputting module outputs the rescue information when a phone call to the predetermined telephone number is established. In at least one embodiment, the outputting module activates a microphone of the electronic device and outputs the rescue the information, so that the person of the predetermined telephone number knows what happens to the driver of the vehicle. In addition, the outputting module further sends rescue information via a short message or an e-mail.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device that is positioned on a vehicle, the electronic device comprising:
at least one processor; and
a storage system that stores one or more programs, which when executed by the at least one processor, cause the at least one processor to:
calculate a speed of the vehicle according to location information of the vehicle, location information of the vehicle being obtained from a Global Positioning System (GPS) device of the electronic device;
determine whether the speed exceeds a predetermined threshold;
monitor a change of the speed of the vehicle and a change of a gradient of the vehicle under the condition that the speed exceeds the predetermined threshold, the change of the gradient of the vehicle being monitored by a gradient device of the electronic device;
determine whether an accident happens to the vehicle according to the change of the speed of the vehicle, the change of the gradient of the vehicle and the location information of the vehicle;
generate rescue information upon the condition that the accident happens to the vehicle; and
dial a predetermined telephone number and output the rescue information when a phone call to the predetermined telephone number is established.

2. The electronic device of claim 1, wherein the accident is determined to happen to the vehicle when the speed of the vehicle is decreased to zero within a predetermined duration.

3. The electronic device of claim 1, wherein the accident is determined to happen to the vehicle when the gradient of the vehicle is dramatically changed within a predetermined duration.

4. The electronic device of claim 1, wherein the accident is determined to happen to the vehicle when the vehicle is not located on any road of an electronic map according to the location information of the vehicle.

5. The electronic device of claim 1, wherein rescue information includes accident location information of the vehicle, and an accident time, a name of a driver, and a picture of the driver when the accident happens to the vehicle.

6. A vehicle monitoring method implemented by an electronic device of a vehicle, the method comprising:
calculating a speed of the vehicle according to location information of the vehicle, location information of the vehicle being obtained from a GPS device of the electronic device;
determining whether the speed exceeds a predetermined threshold;
monitoring a change of the speed of the vehicle and a change of a gradient of the vehicle, the change of the gradient of the vehicle being monitored by a gradient device of the electronic device;
determining whether an accident happens to the vehicle according to the change of the speed of the vehicle under the condition that the speed exceeds the predetermined threshold, the change of the gradient of the vehicle and the location information of the vehicle;
generating rescue information upon the condition that the accident happen to the vehicle; and
dialing a predetermined telephone number and outputting the rescue information when a phone call to the predetermined telephone number is established.

7. The method of claim 6, wherein the accident is determined to happen to the vehicle when the speed of the vehicle is decreased to zero within a predetermined duration.

8. The method of claim 6, wherein the accident is determined to happen to the vehicle when the gradient of the vehicle is dramatically changed within a predetermined duration.

9. The method of claim 6, wherein the accident is determined to happen to the vehicle when the vehicle is not located on any road of an electronic map according to the location information of the vehicle.

10. The method of claim 6, wherein rescue information includes accident location information of the vehicle, an accident time, a name of a driver, and a picture of the driver when the accident happens to the vehicle.

11. A non-transitory computer-readable medium having stored thereon instructions that, when executed by an electronic device of a vehicle, causing the electronic device to perform a vehicle monitoring method, the method comprising:
calculating a speed of the vehicle according to location information of the vehicle, location information of the vehicle being obtained from a GPS device of the electronic device;
determining whether the speed exceeds a predetermined threshold;
monitoring a change of the speed of the vehicle and a change of a gradient of the vehicle, the change of the gradient of the vehicle being monitored by a gradient device of the electronic device;
determining whether an accident happens to the vehicle according to the change of the speed of the vehicle under the condition that the speed exceeds the predetermined threshold, the change of the gradient of the vehicle and the location information of the vehicle;
generating rescue information upon the condition that the accident happen to the vehicle; and
dialing a predetermined telephone number and outputting the rescue information when a phone call to the predetermined telephone number is established.

12. The medium of claim 11, wherein the accident is determined to happen to the vehicle when the speed of the vehicle is decreased to zero within a predetermined duration.

13. The medium of claim 11, wherein the accident is determined to happen to the vehicle when the gradient of the vehicle is dramatically changed within a predetermined duration.

14. The medium of claim 11, wherein the accident is determined to happen to the vehicle when the vehicle is not located on any road of an electronic map according to the location information of the vehicle.

15. The medium of claim 11, wherein rescue information includes accident location information of the vehicle, an accident time, a name of a driver, and a picture of the driver when the accident happens to the vehicle.
